(19) United States
(12) Patent Application Publication
(10) Pub. No.: US 2004/0120651 A1
(43) Pub. Date: Jun. 24, 2004

(54) Planar light-wave-guide element and method for aligning the same with an optical fiber array

(76) Inventor: Sean Huang, Datsuen Shiang (TW)

Correspondence Address: PRO-TECHTOR INTERNATIONAL, 20775 Norada Court, Saratoga, CA, 95070-3018, US

(21) Appl. No.: 10/396,758

(22) Filed: Mar. 24, 2003

(30) Foreign Application Priority Data
Dec. 20, 2002 (TW) 91137002

(51) Int. Cl. G02B 6/26

(52) U.S. Cl. 385/52; 385/14

(57) ABSTRACT

A planar light-waveguide element is disclosed in this invention. The planar light-waveguide element includes a plurality of waveguide circuits and two straight waveguide circuits separately formed on each side of the planar light-waveguide element. Also, the coupling ends of the straight waveguide circuits are parallel to and coplanar with the coupling ends of the waveguide circuits. The planar light-waveguide element in the invention is aligned with and connected to at least one optical fiber array rapidly.

### BACKGROUND OF THE INVENTION

1. Field of the Invention

The invention relates to a planar light-waveguide element and a method for aligning an optical fiber array with the same. More particularly, the invention relates to a planar light-waveguide element having a structure for aligning itself with an optical fiber array in a coupling process and the related method.

2. Description of the Related Art

The rising development of optical communication technologies is based on the inherent advantages of high bandwidth, low transmission loss and non-electromagnetic interference. Generally, a planar light-waveguide element performing works such as light splitting/coupling and optical switching is fabricated on a silicon substrate by applying semiconductor techniques. Thus, a planar light-waveguide element is highly compatible with an optical fiber material and widely employed as a main optical communication element.

In general, a planar light-waveguide element is coupled with at least one optical fiber array. As referred to FIG. 1, a plurality of waveguide circuits 2 are formed on the substrate 3 of a planar light-waveguide element 1. These waveguide circuits 2 are formed by lithography and etching and designed in mask patterning (not shown). Further, the optical fiber array 4 is formed by fastening a plurality of optical fibers 6 to an optical fiber connector 5. In the coupling process for the planar light-waveguide element 1 and the optical fiber array 4, the light waves emitted from a light source 7 is directed into the whole waveguide circuits 2 through the directing-in end 8 of the waveguide circuits 2 so that the light waves can pass through the coupling area 9 and then enter into the corresponding optical fibers 6. Subsequently, a power meter 10 is used to receive these light waves, and the power intensity of the received light waves is applied to adjust the coupling positions between the waveguide circuits 2 and the corresponding optical fibers 6 within the coupling area 9. Finally, when the power intensity achieves a maximum, we are sure that each of the waveguide circuits 2 is aligned with the corresponding optical fiber 6 and therefore the coupling positions can be fixed. Because the refractive index in the core of the waveguide circuits 2 is larger than that in the cladding, the light will be confined within the waveguide for transmission. Further, a variation in optical length or sectional shapes of the core can be utilized to manufacture all kinds of planar light-waveguide circuits, as shown in FIG. 2A to FIG. 2D.

As mentioned above, a conventional alignment for the coupling position between the planar light-waveguide element and the optical fiber array is judged by detecting the coupling power between the waveguide circuits and the optical fiber array by the coupling meter; therefore, the alignment is often affected by the pattern designs of the planar light-waveguide circuits. As a result, the conventional method of alignment makes it more difficult to adjust the coupling position. To be specific, since the curves patterned on the planar light-waveguide circuit are varied and complicated, the power of light waves after passing through the waveguide circuits is reduced. As a result, not only the receiving effect of the power meter is influenced, but also the searching for a maximum value of the coupling power becomes more difficult. Eventually, a problem of hard assembling the planar light-waveguide element and the optical fiber array may occur.

Therefore, in order to facilitate the alignment between the planar light-waveguide element and the optical fiber array as well as to enhance the speed of coupling, the invention provides an effective method for aligning the planar light-waveguide element with the optical fiber array.

### SUMMARY OF THE INVENTION

To solve the foregoing alignment problem between the planar light-waveguide element and the optical fiber array when they are coupled to each other, the first object of the invention is to provide a planar light-waveguide element having a structure for precisely and rapidly aligning and coupling it with an optical fiber array.

The second object of the invention is to provide a method for aligning a planar light-waveguide element with an optical fiber array, wherein the method will not be disturbed by the pattern designs of the planar light-waveguide circuits so as to facilitate the alignment between the planar light-waveguide element and the optical fiber array as well as enhance the speed of coupling.

According to the first aspect of the invention, a provided planar light-waveguide element includes a plurality of waveguide circuits and two straight waveguide circuits, wherein the straight waveguide circuits are separately formed on each side of the planar light-waveguide element. Besides, the coupling ends of the straight waveguide circuits are parallel to and coplanar with the coupling ends of the waveguide circuits. Also, the core size and the refractive index belonging to the straight waveguide circuits are the same as those belonging to the waveguide circuits. In one embodiment, the coupling ends of the waveguide circuits are the light directing-in ends of the waveguide circuits, whereas in another embodiment, the coupling ends of the waveguide circuits are the light directing-out ends of the waveguide circuits.

According to the first aspect of the invention, the provided planar light-waveguide element can further be coupled to an optical fiber array, wherein the optical fiber array includes a plurality of optical transmission fibers and two optical alignment fibers. The two optical alignment fibers are separately provided on each side of the optical fiber array. Besides, the coupling ends of the optical alignment fibers are parallel to and coplanar with the coupling ends of the optical transmission fibers. Each coupling end of the straight waveguide circuits is connected to its corresponding coupling end of the optical alignment fibers, whereas each coupling end of the waveguide circuits is connected to its corresponding coupling end of the optical transmission fibers.

In one embodiment, the coupling ends of the waveguide circuits are the light directing-in ends of the waveguide circuits, whereas in another embodiment, the coupling ends of the waveguide circuits are the light directing-out ends of the waveguide circuits.

According to the second aspect of the invention, the provided method for aligning the planar light-waveguide element with the optical fiber array includes the following steps.

The first step is to provide the planar light-waveguide element, wherein a plurality of waveguide circuits are formed thereon and at least two straight waveguide circuits are separately formed on each side of the planar light-waveguide element, and the coupling ends of the straight waveguide circuits are parallel to and coplanar with the coupling ends of the waveguide circuits; the second step is to provide the optical fiber array consisting of a plurality of optical transmission fibers and at least two optical alignment fibers; the coupling ends of the optical alignment fibers are parallel to and coplanar with those of the optical transmission fibers; in addition, the distance between each coupling end of the optical alignment fibers and the adjacent coupling end of the optical transmission fibers are the same as the distance between each coupling end of the straight waveguide circuits and the adjacent coupling end of the waveguide circuits; the third step is to let the planar light-waveguide element and the optical fiber array be face to face so that the coupling ends of the straight waveguide circuits and the coupling ends of the optical alignment fibers are opposite to each other; the fourth step is to provide power meters at the end of the straight waveguide circuits respectively and to direct light waves into the optical alignment fibers so that the light waves can be received by the power meters after they have passed through the straight waveguide circuits; and the final step is to adjust the coupling between the optical fiber array and the planar light-waveguide element so that the detected power values from the power meters can be a maximum.

In one embodiment, the core-size and the refractive index belonging to the straight waveguide circuits are the same as those belonging to the waveguide circuits. In addition, the designs of the straight waveguide circuits and the waveguide circuits are carried out simultaneously in the mask making of a semiconductor fabrication.

The advantages of the invention are that the alignment made between the planar light-waveguide element and the optical fiber array is completed in a more convenient manner and that the speed of coupling between the two is enhanced.

### BRIEF DESCRIPTION OF THE DRAWINGS

FIG. 1 is a schematic diagram showing an overall conventional architecture in which a planar light-waveguide element is completely coupling with an optical fiber array.

FIG. 2A is a schematic diagram showing a conventional pattern of planar light-waveguide circuits.

FIG. 2B is a schematic diagram showing a conventional pattern of planar light-waveguide circuits.

FIG. 2C is a schematic diagram showing a conventional pattern of planar light-waveguide circuits.

FIG. 2D is a schematic diagram showing a conventional pattern of planar light-waveguide circuits.

FIG. 3 is a top view showing an overall architecture of the planar light-waveguide element and the optical fiber array according to the first embodiment of the invention.

FIG. 4 is a flowchart showing the steps of alignment made between the planar light-waveguide element and the optical fiber array according to the first embodiment of the invention.

FIG. 5 is a top view showing an overall architecture of the planar light-waveguide element and the optical fiber array according to the second embodiment of the invention.

FIG. 6 is a flowchart showing the steps of alignment made between the planar light-waveguide element and the optical fiber arrays for transmission according to the second embodiment of the invention.

FIG. 7 is a schematic diagram showing sectional views of the planar light-waveguide element and the optical fiber array in alignment.

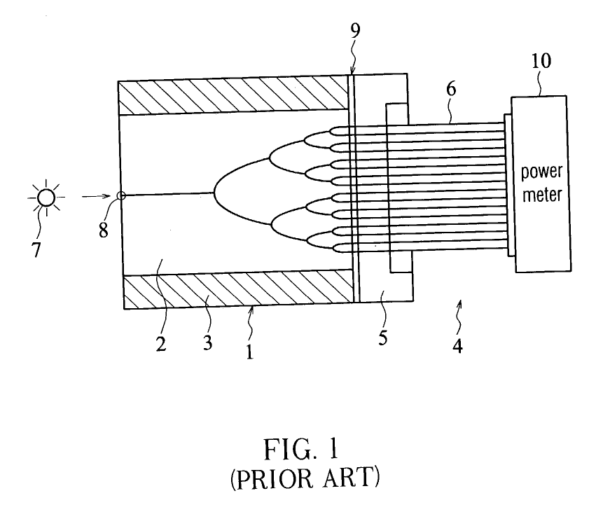

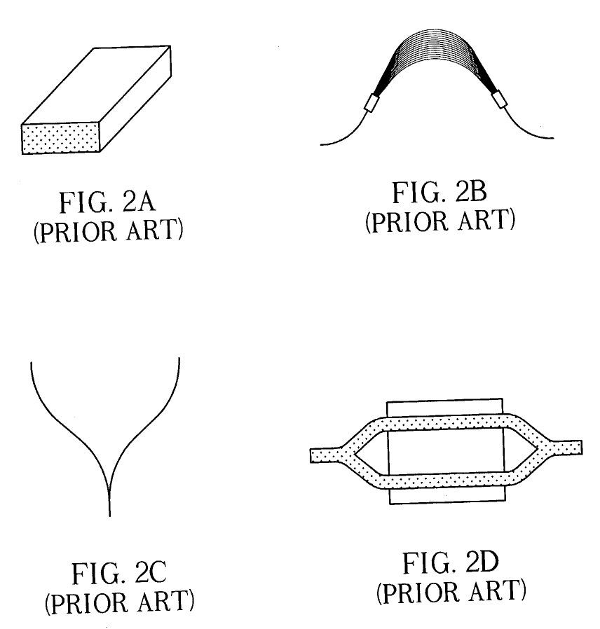

### DESCRIPTION OF THE PREFERRED EMBODIMENTS

The primary content of the invention is to provide two or more than two straight waveguides in a planar light-waveguide element having waveguide circuits of any style at the stage of mask making, wherein the core-size (including height and width) and the refractive index belonging to the straight waveguides are the same as those belonging to the main waveguide circuits. Since the straight waveguide circuits are provided during the mask making process, the other processing procedures will not be disturbed in semiconductor fabrication. Furthermore, the straight waveguides can be used to align the planar light-waveguide element with the optical fiber array when they are coupled to each other. In the following description, an embodiment will be explained in detail to illustrate the characteristics of the planar light-waveguide element according to the invention and the method for aligning the planar light-waveguide element and the optical fiber array.

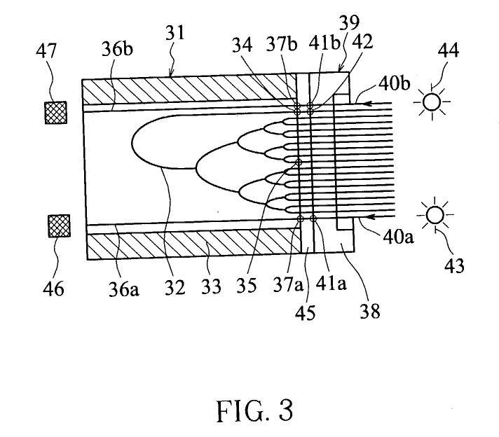

FIG. 3 is a top view showing an overall architecture of the planar light-waveguide element and the optical fiber array according to the first embodiment of the invention. The planar light-waveguide element 31 in the first embodiment has the following characteristics. First, the waveguide circuits 32 are formed on a substrate 33, and the directing-in end 34 and the directing-out ends 35 of the waveguide circuits 32 are located on the same side, that is, the planar light-waveguide element 31 has a one-sided style. Second, two straight waveguides 36a & 36b are formed separately at each side of the substrate 33, wherein the core-size (including height and width) and the refractive index belonging to the straight waveguides 36a & 36b are the same as those belonging to the waveguide circuits 32. Third, the coupling ends 37a & 37b of the straight waveguides 36a & 36b and the directing-out ends 35 of the waveguide circuits 32 are arranged in a parallel manner, and the space between each coupling end and the adjacent end are the same. Besides, the optical fiber array 39 is fixed to an optical fiber connector 38. In addition, two optical fibers 40a & 40b used for alignment are provided on the optical fiber connector 38. The space between each coupling end 41a & 41b and the adjacent coupling end 42 are the same as the space between each coupling end 37a & 37b and the adjacent end.

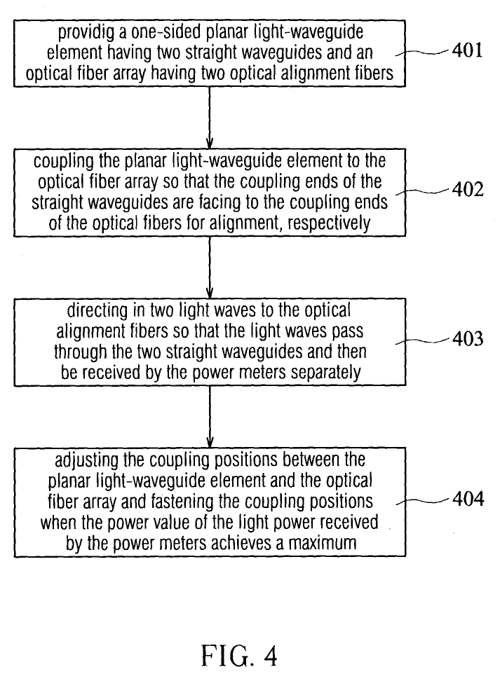

Hence, when the planar light-waveguide element 31 is coupled to the optical fiber array 39, each directing-out end 35 of the waveguide circuits 32 is corresponding to its relative coupling end 42 of the optical fiber array 39, whereas the coupling ends 37a & 37b of the straight waveguides 36a & 36b are corresponding to the coupling ends 41a & 41b of the optical fibers 40a & 40b for alignment, respectively. Therefore, each directing-out end 35 and the corresponding coupling end 42 can be aligned automatically at the time that the coupling ends 37a & 37b and the coupling ends 41a & 41b are aligned. FIG. 4 is a flowchart briefly describing the steps for aligning the planar light-waveguide element 31 and the optical fiber array 39 according to the embodiment. The detail descriptions of each step are as follows.

Step 401: providing the planar light-waveguide element 31 and the optical fiber array 39.

Step 402: coupling the planar light-waveguide element 31 to the optical fiber array 39 so that the coupling ends 37a & 37b of the straight waveguides 36a & 36b are facing to the coupling ends 41a & 41b of the optical alignment fibers 40a & 40b, respectively.

Step 403: directing in two light waves to the optical alignment fibers 40a & 40b from the two light sources 43 & 44 so that the light waves pass through the coupling area 45, two straight waveguides 36a & 36b and then be received by the power meters 46 & 47.

Step 404: adjusting the coupling position between the planar light-waveguide element 31 and the optical fiber array 39, and fastening the coupling position between the planar light-waveguide element 31 and the optical fiber array 39 when the power value of the light power received by the power meters 46 & 47 achieves a maximum.

It should be noted that as long as the alignment can be achieved by employing straight waveguides 36a formed on the substrate in the embodiment, the space between each coupling end 37a & 37b of the straight waveguides 36a & 36b and the adjacent end of the waveguide circuits 32 is not necessary to be the same as the space between any two adjacent directing-out ends 35. In this manner, the space between each coupling end 41a & 41b of the optical fibers 40a & 40b and the adjacent end of the optical fiber array 39 must be changed accordingly so that the coupling ends 41a & 41b can be connected to the coupling ends 37a & 37b of the straight waveguides 36a & 36b respectively, and that each coupling end 42 of the optical fiber array 39 can be connected to each directing-out end 35 of the waveguide circuits 32. In addition, the number of straight waveguides and their corresponding optical alignment fibers is not limited to two. The directing-in ends and the directing-out ends are not limited to be located at the same sides, and the patterns of waveguide circuits can be any style.

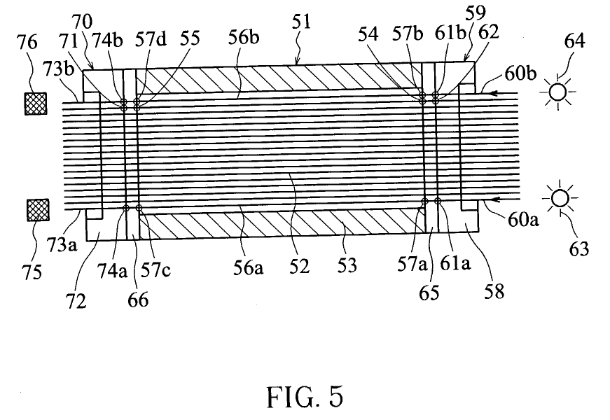

FIG. 5 is a top view showing an overall architecture of the planar light-waveguide element and the optical fiber array according to a second embodiment of the invention. The directing-in ends 54 and directing-out ends 55 of the waveguide circuits 52 formed on the substrate 53 of the planar light-waveguide element 51 in the second embodiment are located at different sides, that is, the planar light-waveguide element 51 is a two-sided style. Besides, the characteristics of the planar light-waveguide element 51 are the same as those of the planar light-waveguide element 31; therefore, they will not be reiterated. Likewise, the optical fiber arrays 59 & 70 in the second embodiment are similar to the optical fiber array 39 in the first embodiment; therefore, they will not be reiterated.

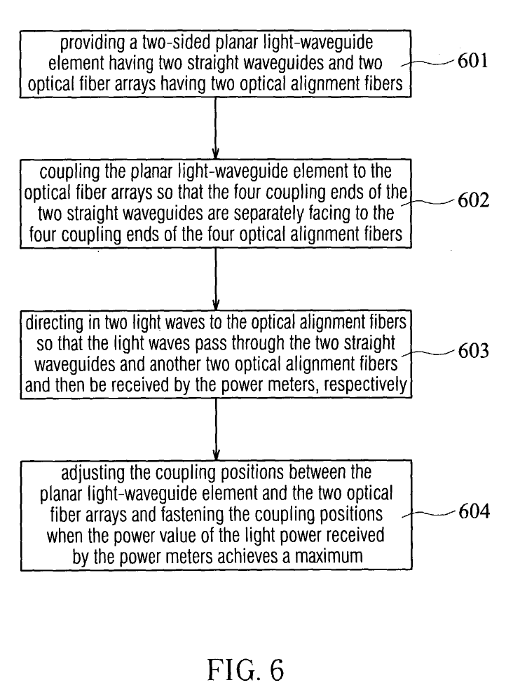

In the embodiment, when the planar light-waveguide element 51 is coupled to the optical fiber arrays 59 & 70, each of the directing-in end 54 of the waveguide circuits 52 is corresponding to its relative coupling end 62 of the optical fiber array 59, whereas each of the directing-out end 55 of the waveguide circuits 52 is corresponding to its relative coupling end 71 of the optical fiber array 70. On the other hand, the coupling ends 57a & 57b are corresponding to the coupling ends 61a & 61b respectively, whereas the coupling ends 57c & 57d are corresponding to the coupling ends 74a & 74b respectively. Therefore, each directing-in end 54 and each coupling end 62 is aligned automatically and each directing-out end 55 and each coupling end 71 is aligned automatically as long as the coupling ends 57a, 57b, 57c & 57d and the coupling ends 61a, 61b, 74a & 74b are aligned, respectively. FIG. 6 is a flowchart showing the steps for aligning the planar light-waveguide element 51 and the optical fiber arrays 59 & 70 in the second embodiment. The detailed descriptions of each step are as follows.

Step 601: providing the planar light-waveguide element 51 and the optical fiber arrays 59 & 70.

Step 602: coupling the planar light-waveguide element 51 to the optical fiber arrays 59 & 70 so that the four coupling ends 57a, 57b, 57c & 57d of the two straight waveguides 56a & 56b separately face to the four coupling ends 61a, 61b, 74a & 74b of the optical alignment fibers 60a, 60b, 73a & 73b.

Step 603: directing in two light waves to the optical alignment fibers 60a & 60b from the two light sources 63 & 64 so that the light waves pass through the coupling area 65, two straight waveguides 56a & 56b, coupling area 66, two optical fibers 73a & 73b, and then be received by the power meters 75 & 76, respectively.

Step 604: adjusting the coupling position between the planar light-waveguide element 51 and the optical fiber arrays 59 & 70, and fastening the coupling position between the planar light-waveguide element 51 and the optical fiber arrays 59 & 70 when the power value of the light power received by the power meters 75 & 76 achieves a maximum.

It should be noted that as long as the straight waveguides 56a &56b formed on the substrate in the embodiment are coplanar with the waveguide circuits 52, the space between each coupling end 57a & 57b and its adjacent end is not necessary to be the same as the space between any two adjacent directing-in ends 54. Likewise, the space between each coupling end 57c & 57d and its adjacent end is not necessary to be the same as the spaces between any two adjacent directing-out ends 55. In this manner, the space between each coupling end 61a & 61b and the adjacent coupling end 62 must be changed accordingly so that the coupling ends 61a & 61b can be connected to the coupling ends 57a & 57b, respectively, and that each coupling end 62 can be separately connected to each directing-in end 54. On the other hand, the space between each coupling end 74a & 74b and its adjacent coupling end 71 must be changed accordingly so that the coupling ends 74a & 74b can be connected to the coupling ends 57c & 57d, respectively, and that each coupling end 71 can be connected to each directing-out end 55, respectively. In the embodiment, the number of straight waveguides and the number of their corresponding optical alignment fibers is not limited to two, the number of directing-in ends and the number of directing-out ends is not limited to be equal, and the patterns of waveguide circuits can be any style.

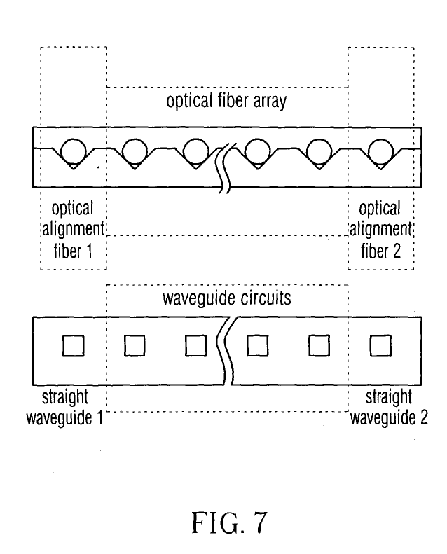

FIG. 7 is a schematic diagram showing a sectional view of the planar light-waveguide element and the optical fiber array in alignment. As shown in FIG. 7, the planar light-waveguide element is manufactured in semiconductor fabrication and all the waveguide channels are located on the same plane. In this manner, the main optical fiber array and the waveguide circuits are aligned automatically when the alignment of the optical fibers 1 & 2 with the straight waveguides 1 &2 is completed.

Summing up, the invention has been described in detail through the above examples and embodiments. However, the foregoing embodiments are only intended to illustrate the invention; they do not limit the invention to the specific embodiments. Accordingly, various modifications and changes may be made; for example, the waveguide circuits in the planar light-waveguide element can be any pattern. Therefore, the invention is limited by the appended claims without departing from the spirit and scope of the invention.

What is claimed is:

1. A planar light-waveguide element, comprising:
a plurality of waveguide circuits; and
two straight waveguide circuits separately formed on each side of the planar light-waveguide element, wherein the coupling ends of the straight waveguide circuits are parallel to and coplanar with the coupling ends of the waveguide circuits.

2. The planar light-waveguide element as claimed in claim 1, wherein the coupling ends of the waveguide circuits are directing-in ends of the waveguide circuits.

3. The planar light-waveguide element as claimed in claim 1, wherein the coupling ends of the waveguide circuits are directing-out ends of the waveguide circuits.

4. The planar light-waveguide element as claimed in claim 1, wherein the core-size and the refractive index of the straight waveguide circuits are the same as that of the waveguide circuits.

5. The planar light-waveguide element as claimed in claim 1 further being coupled to an optical fiber array, the optical fiber array comprising:
a plurality of optical transmission fibers; and
two optical alignment fibers separately provided on each side of the optical fiber array with the coupling ends of the optical alignment fibers are parallel to and coplanar with the coupling ends of the optical transmission fibers;
wherein each coupling end of the straight waveguide circuits is connected to the corresponding coupling end of the optical alignment fibers, and each coupling end of the waveguide circuits is connected to the corresponding coupling end of the optical transmission fibers.

6. The planar light-waveguide element as claimed in claim 5, wherein the space between each coupling end of the optical alignment fibers and the adjacent coupling end of the optical transmission fibers are the same as the space between each coupling end of the straight waveguide circuits and the adjacent coupling end of the waveguide circuits.

7. The planar light-waveguide element as claimed in claim 5, wherein the coupling ends of the waveguide circuits are directing-in ends.

8. The planar light-waveguide element as claimed in claim 5, wherein the coupling ends of the waveguide circuits are directing-out ends.

9. An method for aligning a planar light-waveguide element with a optical fiber array, comprising the following steps:
providing the planar light-waveguide element with a plurality of waveguide circuits formed thereon and at least two straight waveguide circuits separately formed on each side of the planar light-waveguide element, the coupling ends of the straight waveguide circuits are parallel to and coplanar with the coupling ends of the waveguide circuits;
providing the optical fiber array, which consists of a plurality of optical transmission fibers and at least two optical alignment fibers, the coupling ends of the optical alignment fibers are parallel to and coplanar with the coupling ends of the optical transmission fibers, and the space between each coupling end of the optical alignment fibers and the adjacent coupling end of the optical transmission fibers is the same as the space between each coupling end of the straight waveguide circuits and the adjacent coupling end of the waveguide circuits; and
allowing the planar light-waveguide element and the optical fiber array to face each other so that the coupling ends of the straight waveguide circuits are opposite to the coupling ends of the optical alignment fibers.

10. The method for aligning the planar light-waveguide element with the optical fiber array as claimed in claim 9, further comprising the following steps:
separately providing power meters at the ends of the straight waveguide circuits and separately introducing the light waves into the optical alignment fibers so that the light waves pass through the straight waveguide circuits and are received by the power meters; and
adjusting the coupling positions between the planar light-waveguide element and the optical fiber array so that the power value of the received light waves achieves a maximum.

11. The method for aligning the planar light-waveguide element with the optical fiber array as claimed in claim 9, wherein the core-size and the refractive index of the straight waveguide circuits are the same as that of the waveguide circuits.

12. The method for aligning the planar light-waveguide element with the optical fiber array as claimed in claim 9, wherein the waveguide circuits and the straight waveguide circuits are designed in the mask making process of a semiconductor processing.
